(19) United States
(12) Patent Application Publication
(10) Pub. No.: US 2025/0218155 A1
(43) Pub. Date: Jul. 3, 2025

(54) METHOD AND APPARATUS WITH OBJECT DETECTION

(71) Applicant: Samsung Electronics Co., Ltd., Suwon-si (KR)

(72) Inventors: Ju Hwan SONG, Suwon-si (KR); Seungin PARK, Suwon-si (KR); Byung In YOO, Suwon-si (KR); Sangil JUNG, Suwon-si (KR)

(73) Assignee: Samsung Electronics Co., Ltd., Suwon-si (KR)

(21) Appl. No.: 18/755,393

(22) Filed: Jun. 26, 2024

(30) Foreign Application Priority Data
Jan. 3, 2024 (KR) 10-2024-0001018

(51) Int. Cl. G06V 10/75; G06V 10/74; G06V 10/764; G06V 10/766; G06V 10/774

(52) U.S. Cl. CPC G06V 10/759; G06V 10/761; G06V 10/764; G06V 10/766; G06V 10/774

(57) ABSTRACT

A method of training an object detector including obtaining a first tracklet set based on an object detection result output corresponding to a plurality of frames, obtaining a second tracklet set from ground truth data predetermined corresponding to the plurality of frames, obtaining a first bipartite matching result of a bounding box level, the bounding box level corresponding to each of first tracklets included in the first tracklet set and each of second tracklets included in the second tracklet set, obtaining a second bipartite matching result of a tracklet level, the tracklet level corresponding to the first tracklet set and the second tracklet set, based on the first bipartite matching result, and assigning a second tracklet determined to be one of a pair including a first tracklet, as a paired first tracklet and second tracklet, to ground truth data of the first tracklet, based on the second bipartite matching result.

### CROSS-REFERENCE TO RELATED APPLICATIONS

This application claims the benefit under 35 USC § 119(a) of Korean Patent Application No. 10-2024-0001018, filed on Jan. 3, 2024, in the Korean Intellectual Property Office, the entire disclosure of which is incorporated herein by reference for all purposes.

### BACKGROUND

### 1. Field

The following description relates to a method and apparatus with object detection.

### 2. Description of Related Art

Object detection technology, which is a computer technology related to computer vision and image processing, typically includes detecting a semantic object instance of a certain series through a digital image or video. Besides technology for detecting an object in a two-dimensional (2D) image, deep learning-based 3D object detection technology using light detection and ranging (LiDAR) data has also been developed. An object detector may include a 1-stage detector that obtains a feature map by passing input data, such as an image or a point cloud, through a backbone model and then obtains a bounding box and a class classification result by passing the obtained feature map through modules and a 2-stage detector that enhances accuracy by refining pieces of information by additionally applying a post-processing module to region of interest (ROI) information (region proposal) output from the 1-stage detector.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, here is provided a method of training an object detector including obtaining a first tracklet set based on an object detection result output corresponding to a plurality of frames, obtaining a second tracklet set from ground truth data predetermined corresponding to the plurality of frames, obtaining a first bipartite matching result of a bounding box level, the bounding box level corresponding to each of first tracklets included in the first tracklet set and each of second tracklets included in the second tracklet set, obtaining a second bipartite matching result of a tracklet level, the tracklet level corresponding to the first tracklet set and the second tracklet set, based on the first bipartite matching result, and assigning a second tracklet determined to be one of a pair including a first tracklet, as a paired first tracklet and second tracklet, to ground truth data of the first tracklet, based on the second bipartite matching result.

The obtaining the first bipartite matching result may include obtaining the first bipartite matching result based on a first cost, the first cost resulting from a first similarity of a first bounding box included in the first tracklet and a second bounding box included in the second tracklet.

The first cost may be determined based on at least one of a probability in which a first class of the first bounding box is a similar class as a second class of the second bounding box, a difference between first coordinates of the first bounding box and second coordinates of the second bounding box, a difference between a first size of the first bounding box and a second size the second bounding box, and a difference in a rotation degree between the first bounding box and the second bounding box.

The obtaining the second bipartite matching result may include obtaining the second bipartite matching result based on a second cost, the second cost resulting from a second similarity of the first tracklet and the second tracklet determined from the first bipartite matching result.

The obtaining the second bipartite matching result may include obtaining a first cost of a first bounding box included in the first tracklet determined to be the paired first tracklet and a second bounding box included in the second tracklet, based on the first bipartite matching result, determining a second cost of the first tracklet and the second tracklet, based on the obtained first cost, and obtaining the second bipartite matching result based on the second cost.

The object detector may include an object detector of a 2-stage detector type and wherein the obtaining of the first tracklet set may include obtaining the first tracklet set corresponding to respective trajectories of respective detected objects, based on an object detection result output from a region proposal module of the object detector corresponding to the plurality of frames.

The method may include training the object detector based on the ground truth data of the first tracklet.

The first tracklet may include a plurality of first bounding boxes corresponding to a time interval and the second tracklet may include a plurality of second bounding boxes corresponding to the time interval.

In a general aspect, here is provided an object detection method including obtaining a first tracklet set and a second tracklet set based on an object detection result, obtaining a first bipartite matching result of a bounding box level, the bounding box level corresponding to each of first tracklets included in the first tracklet set and each of second tracklets included in the second tracklet set, obtaining a second bipartite matching result of a tracklet level, the tracklet level corresponding to the first tracklet set and the second tracklet set, based on the first bipartite matching result, and correcting the object detection result based on the second bipartite matching result.

The correcting the object detection result may include synthesizing a first tracklet of the first tracklets that is paired to a second tracklet of the second tracklets as a pair, the pair resulting from the second bipartite matching result.

The obtaining the first tracklet set and the second tracklet set may include obtaining the first tracklet set corresponding to a first respective trajectory of a first respective detected object of first detected objects, based on a first object detection result output from a first object detector corresponding to a plurality of frames and obtaining the second tracklet set corresponding to a second respective trajectory of a second respective object of second detected objects, based on a second object detection result output from a second object detector corresponding to the plurality of frames.

The obtaining the first tracklet set and the second tracklet set may include obtaining the first tracklet set corresponding to a first respective trajectory of a first respective detected object of first detected objects, based on a first object detection result output from a first object detector corresponding to a first plurality of frames obtained from a first sensor and obtaining the second tracklet set corresponding to a second respective trajectory of a second respective object of second detected objects, based on a second object detection result output from a second object detector corresponding to a plurality of frames obtained from a second sensor.

In a general aspect, here is provided a non-transitory, computer-readable storage medium storing instructions that, when executed by a processor, cause the processor to perform the method.

In a general aspect, here is provided an apparatus for training an object detector including processors configured to execute instructions and a memory storing the instructions, wherein execution of the instructions configures the processors to obtain a first tracklet set based on an object detection result output corresponding to a plurality of frames, obtain a second tracklet set from ground truth data predetermined corresponding to the plurality of frames, obtain a first bipartite matching result of a bounding box level, the bounding box level corresponding to each of first tracklets included in the first tracklet set and each of second tracklets included in the second tracklet set, obtain a second bipartite matching result of a tracklet level, the tracklet level corresponding to the first tracklet set and the second tracklet set, based on the first bipartite matching result, and assign a second tracklet determined to be one of a pair including a first tracklet, as a paired first tracklet and second tracklet, to ground truth data of the first tracklet, based on the second bipartite matching result.

The processors may further be configured to, when obtaining the first bipartite matching result, obtain the first bipartite matching result based on a first cost, the first cost resulting from a first similarity of a first bounding box included in the first tracklet and a second bounding box included in the second tracklet.

The processors may further be configured to, when obtaining the second bipartite matching result, obtain the second bipartite matching result based on a second cost, the second cost resulting from a second similarity of the first tracklet and the second tracklet determined from the first bipartite matching result.

The processors may further be configured to, when obtaining the second bipartite matching result, obtain a first cost of a first bounding box included in the first tracklet determined to be the paired first tracklet and a second bounding box included in the second tracklet, based on the first bipartite matching result, determine a second cost of the first tracklet and the second tracklet, based on the obtained first cost, and obtain the second bipartite matching result based on the second cost.

The object detector may include an object detector of a 2-stage detector type and the processors may further be configured to obtain the first tracklet set corresponding to respective trajectories of respective detected objects, based on an object detection result output from a region proposal module of the object detector corresponding to the plurality of frames.

The processors may further be configured to train the object detector based on the ground truth data of the first tracklet.

In a general aspect, here is provided an apparatus for object detection including processors configured to execute instructions and a memory storing the instructions, wherein execution of the instructions configures the processors to obtain a first tracklet set and a second tracklet set based on an object detection result, obtain a first bipartite matching result of a bounding box level, the bounding box level corresponding to each of first tracklets included in the first tracklet set and each of second tracklets included in the second tracklet set, obtain a second bipartite matching result of a tracklet level, the tracklet level corresponding to the first tracklet set and the second tracklet set, based on the first bipartite matching result, and correct the object detection result based on the second bipartite matching result.

### BRIEF DESCRIPTION OF THE DRAWINGS

FIG. 1 illustrates an example method of training an object detector, according to one or more embodiments.

FIG. 2 illustrates an example structure of a 2-stage detector according to one or more embodiments.

FIG. 3 illustrates an example tracklet of an object according to one or more embodiments.

FIG. 4 illustrates an example of bipartite matching of a bounding box level corresponding to a first tracklet and a second tracklet according to one or more embodiments.

FIGS. 5A to 5C each illustrate examples of first bipartite matching results according to one or more embodiments.

FIG. 6 illustrates an example of bipartite matching of a tracklet level corresponding to a first tracklet set and a second tracklet set according to one or more embodiments.

FIG. 7 illustrates an example method of determining a second cost according to one or more embodiments.

FIG. 8 illustrates an example object detection method according to one or more embodiments.

FIG. 9 illustrates an example method of double bipartite matching of a tracklet set obtained from object detection results of different object detectors according to one or more embodiments.

FIG. 10 illustrates an example method of double bipartite matching of a tracklet set obtained from object detection results corresponding to signals of different sensors according to one or more embodiments.

FIG. 11 illustrates an example configuration of an apparatus according to one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

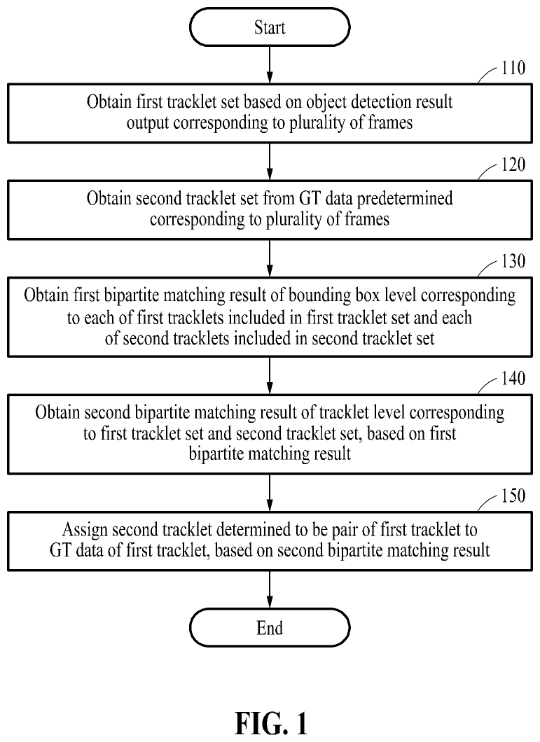

FIG. 1 illustrates an example method of training an object detector, according to one or more embodiments.

In an example, object detector may be a model that outputs a bounding box of an object included in input data and/or a class label of the object. The object detector may include an object detector of a 2-stage detector type. In an example, the object detector may include an object detector based on at least one of a regions with convolutional neural network (R-CNN), a Fast R-CNN, a Faster R-CNN, a region-based fully convolutional network (R-FCN), and a Mask R-CNN of a 2-stage detector type. The input data of the object detector may include at least one type of data among an image, a video, and a point cloud.

Referring to FIG. 1, in a non-limiting example, the method of training an object detector may include operation 110 of obtaining a first tracklet set based on an object detection result output corresponding to a plurality of frames. The plurality of frames may be the input data of the object detector, and a frame may include an image and/or a point cloud.

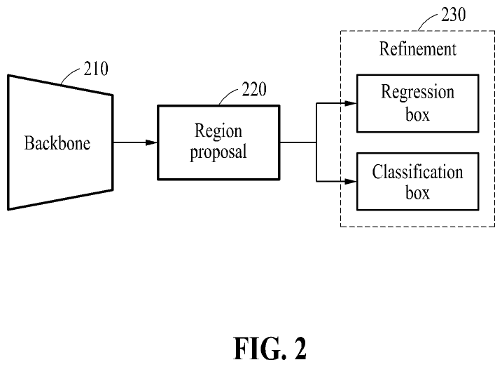

FIG. 2 illustrates an example structure of a 2-stage detector according to one or more embodiments.

Object detection results may be output from a region proposal module of a 2-stage detector. Referring to FIG. 2, in a non-limiting example, a 2-stage detector may include a backbone module 210 configured to output a feature map, which is embedding data of input data, a region proposal module 220 configured to estimate a bounding box of an object corresponding to a region of interest (ROI) from the feature map that is output from the backbone module 210, and a refinement module 230 configured to perform bounding box regression and/or classification from the bounding box of the object that is output from the region proposal module 220. An object detection result may include bounding box information of the object that is output from the region proposal module 220.

In an example, the refinement module 230 may be a module for enhancing the accuracy of object detection by refining the object detection result that is output from the region proposal module 220. The refinement module 230 may perform classification on the object detection result and may estimate a class label of the bounding box of the object. The refinement module 230 may estimate a corrected bounding box of the object through the regression of the bounding box of the object that is output from the region proposal module 220.

In an example, the refinement module 230 may be trained based on a tracklet of each of objects included in object detection results. A tracklet may include a set of bounding box information in which bounding boxes are listed in a chronological order.

Referring back to FIG. 1, in an example, operation 110 of obtaining the first tracklet set may include obtaining the first tracklet set which may correspond to trajectories for each detected object contained within one or more detected objects, based on an object detection result that is output from a region proposal module of the object detector corresponding to the plurality of frames. A first tracklet may be obtained based on the object detection result where the object detection result is output from the region proposal module which corresponds to the plurality of frames. The first tracklet set is a set of first tracklets, which may include one or more first tracklets. An example of a first tracklet of the first tracklet set may correspond to an object included in the object detection result. The first tracklet may correspond to a trajectory of an object included in the object detection result and may include a set of bounding box information in which bounding boxes of that object which was detected in the plurality of frames are listed in a chronological order. When a plurality of objects is detected corresponding to the plurality of frames, the first tracklet set may include a plurality of first tracklets each corresponding to a trajectory for each of those objects. In an example, when a first object and a second object are detected within the plurality of frames, the first tracklet set may include a first tracklet corresponding to the first object and another first tracklet corresponding to the second object.

In an example, the first tracklet set may be obtained based on a tracker configured to estimate a trajectory of an object. The first tracklet set may be obtained corresponding to a trajectory for each of the objects detected in the plurality of frames by inputting the object detection result corresponding to the plurality of frames that is output from the region proposal module to the tracker.

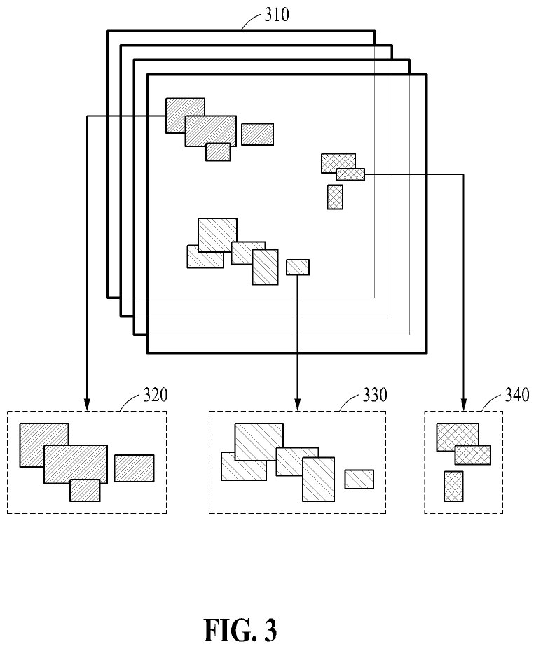

FIG. 3 illustrates an example tracklet of an object according to one or more embodiments.

Referring to FIG. 3, in a non-limiting example, object detection results respectively corresponding to the plurality of frames may be obtained from the region proposal module of the 2-stage detector. Object detection results 310 may include the bounding box information for an object that may be detected in each input frame. The tracker may identify a bounding box of the same object from the object detection results 310 respectively corresponding to the plurality of frames and may estimate a trajectory of the bounding box of the same object according to a chronological order of the plurality of frames. The tracker may obtain a tracklet 320 corresponding to the first object, a tracklet 330 corresponding to the second object, and a tracklet 340 corresponding to a third object from the object detection results 310 that respectively corresponds to the plurality of frames. The first tracklet set may include the tracklet 320 corresponding to the first object, the tracklet 330 corresponding to the second object, and the tracklet 340 corresponding to the third object. One or more tracklets, which are elements included in the first tracklet set, may be referred to as the first tracklets.

Referring back to FIG. 1, in a non-limiting example, the method of training an object detector according to an embodiment may include operation 120 of obtaining a second tracklet set from ground truth (GT) data that is predetermined corresponding to the plurality of frames. The GT data may correspond to that plurality of frames. The second tracklet set may be GT data on a trajectory of a bounding box of at least one object included in the plurality of frames. The second tracklet set is a set of second tracklets, which may include one or more second tracklets. An example of a second tracklet of the second tracklet set may correspond to one object included in the GT data. The second tracklet may correspond to a trajectory of an object included in the GT data and may include a set of bounding box information in which GT bounding boxes of the object which was included in the GT data are listed in a chronological order. When the GT data corresponding to the plurality of frames includes a plurality of objects, the second tracklet set may include a plurality of second tracklets that each correspond to a trajectory for each of those objects. In an example, when the GT data corresponding to the plurality of frames includes the first object and the second object, the second tracklet set may include a second tracklet corresponding to the first object and another second tracklet corresponding to the second object. One or more of these tracklets, which are elements included in the second tracklet set, may be referred to as the second tracklets.

In an example, the method of training an object detector may include operation 130 of obtaining a first bipartite matching result of a bounding box level corresponding to each of the first tracklets included in the first tracklet set and each of the second tracklets included in the second tracklet set. The first bipartite matching result of a bounding box level may include a bipartite matching result of one or more first bounding boxes included in a first tracklet and one or more second bounding boxes included in a second tracklet. The first bipartite matching result may include a pair of second bounding boxes that match the first bounding boxes.

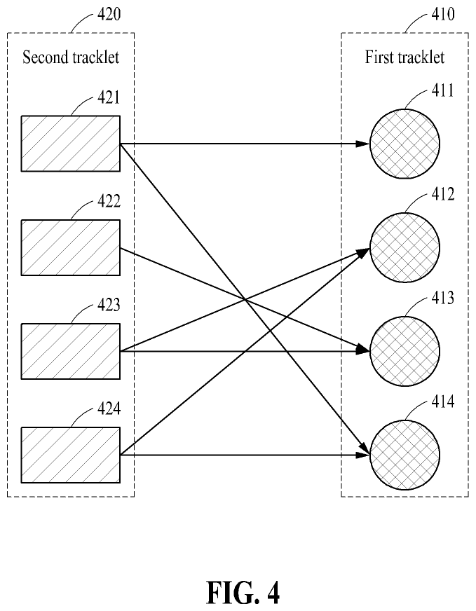

FIG. 4 illustrates an example of bipartite matching of a bounding box level corresponding to a first tracklet and a second tracklet according to one or more embodiments.

Referring to FIG. 4, in a non-limiting example, a bipartite matching of a bounding box level may correspond to a first tracklet 410 and a second tracklet 420 when the first tracklet 410 includes four first bounding boxes and the second tracklet 420 includes four second bounding boxes. The four first bounding boxes 411, 412, 413, and 414 may match with any one, or none, of the four second bounding boxes 421, 422, 423, and 424. In an example, second bounding box 421 may match with both a first bounding box 411 and a first bounding box 414 as illustrated by the arrows from second bounding box 421. However, the number of bounding boxes in either of first tracklet 410 and second tracklet 420 are not limited thereto. A second bounding box 422 may match with a first bounding box 413. A second bounding box 423 may match with both a first bounding box 412 and the first bounding box 413. A second bounding box 424 may match with both the first bounding box 412 and the first bounding box 414. When one of the first bounding boxes matches one of the second bounding boxes, the first bipartite matching result may include a combination of pairs of a first bounding box and a second bounding box, which maximizes the number of matched pairs. In an example, when the second bounding box 421 matches the first bounding box 411, the second bounding box 422 matches the first bounding box 413, the second bounding box 423 matches the first bounding box 412, and the second bounding box 424 matches the first bounding box 414, all the second bounding boxes included in the second tracklet 420 match with all the first bounding boxes included in the first tracklet 410, which is maximum matching, and thus, the matched pairs may be determined to be the first bipartite matching result. FIG. 4 illustrates a line in a direction connecting a second bounding box to a first bounding box, but the direction of the line may change or there may not necessarily be any directionality at all. This may also apply to the bipartite matching of a tracklet level described above other than the bipartite matching of a bounding box level.

A weight or a cost may be applied to the line connecting a first bounding box to a second bounding box. In an example, when a weight is applied to the line connecting a first bounding box to a second bounding box, and the first bounding box included in the first tracklet 410 matches the second bounding box included in the second tracklet 420, the first bipartite matching result may be obtained from a combination of pairs that maximizes the sum of weights of the line connecting the matched first bounding box to the matched second bounding box. In an example, when a cost is applied to the line connecting a first bounding box to a second bounding box, and the first bounding box included in the first tracklet 410 matches the second bounding box included in the second tracklet 420, a combination of pairs that minimizes the sum of costs of the line connecting the matched first bounding box to the matched second bounding box may be obtained as the first bipartite matching result. The weight may be applied to a line of a bipartite graph, but hereinafter, the cost being applied may be provided as an example.

Referring back to FIG. 1, in a non-limiting example, operation 130 of obtaining the first bipartite matching result may include obtaining the first bipartite matching result based on a first cost where the first cost is based on, or results from, a similarity of a first bounding box included in a first tracklet and a second bounding box included in a second tracklet. As the similarity of the first bounding box and the second bounding box increases, the first cost of a line connecting the first bounding box to the second bounding box may be determined to be a smaller value. The first bipartite matching result may include a combination of pairs of a first bounding box included in a first tracklet and a second bounding box included in a second tracklet, which minimizes the sum of first costs. In an example, a first cost for a first bounding box and/or a second bounding box of which a pair is not determined may be determined to be a maximum value predetermined corresponding to the first cost or a sufficiently large value.

In an example, the first cost may be determined based on a probability in which a class of the first bounding box has the same classification of a class of the second bounding box. As the probability in which the class of the first bounding box is has the same, or similar, classification as the class of the second bounding box increases, the first cost may be determined to be a smaller value. In an example, the first cost may be determined based on the difference in coordinates between the first bounding box and the second bounding box. As the difference in coordinates between the first bounding box and the second bounding box decreases, the first cost may become a smaller determined value. For example, the first cost may be determined based on the difference in size between the first bounding box and the second bounding box. As the difference in size between the first bounding box and the second bounding box decreases, the first cost may become a smaller determined value. In an example, the first cost may be determined based on the difference in a rotation degree between the first bounding box and the second bounding box. As the difference in a rotation degree between the first bounding box and the second bounding box decreases, the first cost may become a smaller determined value.

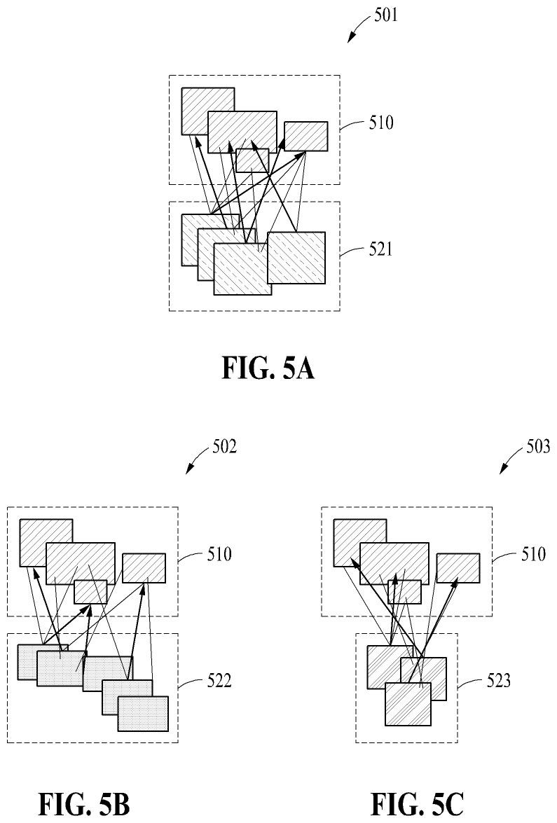

FIGS. 5A to 5C each illustrate examples of first bipartite matching results according to one or more embodiments.

In an embodiment, the first bipartite matching result may be obtained that corresponds to all combinations of all first tracklets included in the first tracklet set and all second tracklets included in the second tracklet set. Referring to FIGS. 5A to 5C, in a non-limiting example, when the second tracklet set includes three second tracklets, a first bipartite matching result 501 between first bounding boxes included in a first tracklet 510 and second bounding boxes included in a second tracklet 521, the first bipartite matching result between the first bounding boxes included in the first tracklet 510 and second bounding boxes included in a second tracklet 522, and the first bipartite matching result between the first bounding boxes included in the first tracklet 510 and second bounding boxes included in a second tracklet 523 may be obtained. When the first tracklet set includes the plurality of first tracklets, the first bipartite matching result corresponding to combinations of each of the plurality of first tracklets included in the first tracklet set and each second tracklet may be obtained.

Referring back to FIG. 1, in a non-limiting example, the method of training an object detector according to an embodiment may include operation 140 of obtaining a second bipartite matching result of a tracklet level that corresponds to the first tracklet set and the second tracklet set, based on the first bipartite matching result. The second bipartite matching result of a tracklet level may include a bipartite matching result between one or more first tracklets included in the first tracklet set and one or more second tracklets included in the second tracklet set. The second bipartite matching result may include a pair of second tracklets matching each of the first tracklets.

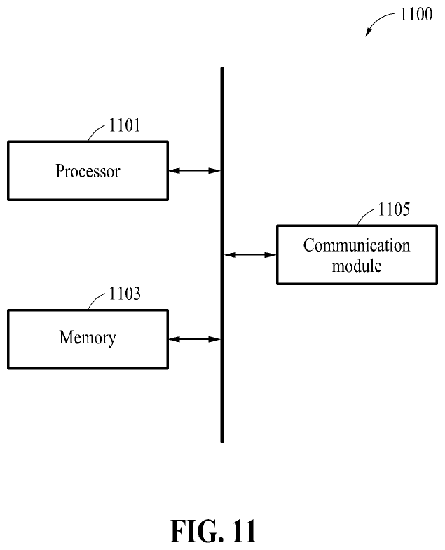

FIG. 11 illustrates an example configuration of an apparatus according to one or more embodiments.

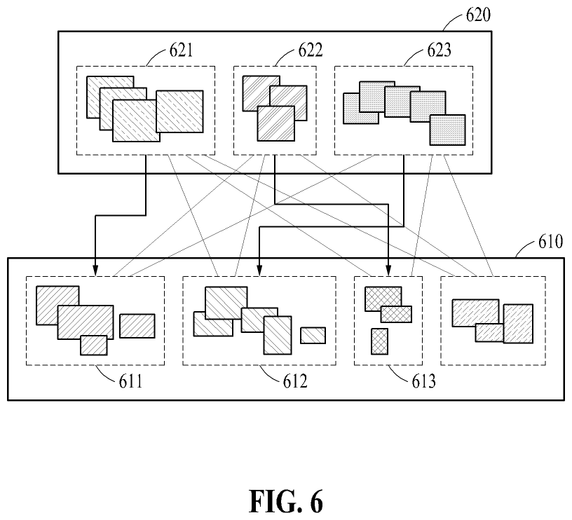

Referring to FIG. 6, in a non-limiting example, bipartite matching of a tracklet level may correspond to a first tracklet set 610 and a second tracklet set 620 when the first tracklet set 610 includes four first tracklets and the second tracklet set 620 includes three second tracklets. Thus, each of the second tracklets included in the second tracklet set 620 may match at least some of the first tracklets included in the first tracklet set 610. When one first tracklet matches one second tracklet, the second bipartite matching result may include a combination of pairs of the first tracklet and the second tracklet, which maximizes the number of matched pairs. In an example, when a second tracklet 621 matches a first tracklet 611, a second tracklet 622 matches a first tracklet 613, and a second tracklet 623 matches a first tracklet 612, all the second tracklets included in the second tracklet set 620 match the first tracklets, which is maximum matching, and thus, the matched pairs may be determined to be the second bipartite matching result. When a plurality of combinations of pairs corresponds to maximum matching, a randomly selected combination among the combinations of the pairs corresponding to the maximum matching may be determined to be the second bipartite matching result, or a combination selected based on a second cost of the combinations of the pairs may be determined to be the second bipartite matching result.

Referring to back FIG. 1, in a non-limiting example, operation 140 of obtaining the second bipartite matching result may include an operation of obtaining the second bipartite matching result based on a second cost on a similarity of the first tracklet and the second tracklet determined from the first bipartite matching result. As the similarity of the first tracklet and the second tracklet increases, the second cost of a line connecting the first tracklet to the second tracklet may be determined to be a smaller value. The second bipartite matching result may include a combination of pairs of a first tracklet included in the first tracklet set and a second tracklet included in the second tracklet set, which minimizes the sum of second costs. In an example, a second cost for a first tracklet and/or a second tracklet of which a pair is not determined may be determined to be a maximum value predetermined corresponding to the second cost or a sufficiently large value.

In an example, the second cost may be determined based on the first bipartite matching result. In an example, operation 140 of obtaining the second bipartite matching result may include an operation of obtaining a first cost of a first bounding box included in the first tracklet determined to be the pair and a second bounding box included in the second tracklet, based on the first bipartite matching result, an operation of determining a second cost of the first tracklet and the second tracklet, based on the obtained first cost, and an operation of obtaining the second bipartite matching result based on the second cost.

The second cost of a first tracklet and a second tracklet may be determined to be an average first cost according to the first bipartite matching result of a bounding box level which may correspond to the first tracklet and the second tracklet. An average first cost of a pair between bounding boxes included in the first bipartite matching result corresponding to a first tracklet and a second tracklet may be determined to be the second cost of the first tracklet and the second tracklet.

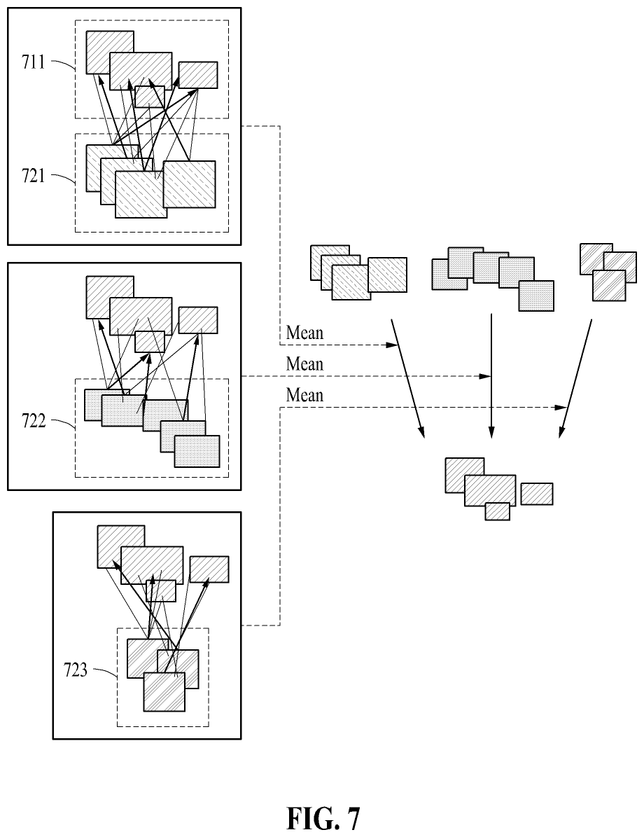

FIG. 7 illustrates an example of a method of determining a second cost according to one or more embodiments.

Referring to FIG. 7, in a non-limiting example, when first costs of four pairs determined by a first bipartite matching result between a first tracklet 711 and a second tracklet 721 are 0.5, 0.6, 0.9, and 0.8, respectively, a second cost of the first tracklet 711 and the second tracklet 721 may then be determined to be 0.7, which is an average of the first costs. Likewise, based on the average of the first costs of four pairs determined by the first bipartite matching result, a second cost of the first tracklet 711 and a second tracklet 722 and a second cost of the first tracklet 711 and a second tracklet 723 may be determined.

Referring back to FIG. 1, in a non-limiting example, a first tracklet may include a plurality of first bounding boxes corresponding to a certain time interval and a second tracklet may include a plurality of second bounding boxes corresponding to the certain time interval (i.e., the first and second bounding boxes are temporally related). In other words, the bipartite matching of the bounding box level may be performed on first bounding box(es) included in the first tracklet and second bounding box(es) included in the second tracklet.

In an example, the second bipartite matching result may be represented by Equation 1 below.

$$\partial \text{?} = arg min \text{?} {{\sum }_{i}}^{N} {L}_{match 2} ( T \text{?} , T \text{?} ) \qquad Equation 1$$

$$\text{?} \text{indicates text missing or illegible when filed}$$

In Equation 1, \hat{σ}_{T} denotes a second bipartite matching result of a tracklet level corresponding to a first tracklet set and a second tracklet set. In Equation 1, σ_{T} denotes any one among all combinations P₂_{_{N}} of possible bipartite matching between the first tracklet set and the second tracklet set.

In Equation 1, T̅ and T denote two tracklet sets to be compared, which may be the first tracklet set and the second tracklet set, respectively. In Equation 1, Tᵢ denotes any one second tracklet included in T, and T̅_{σ}_{_{T}}(l) denotes a first tracklet determined to be a pair of Tᵢ in σ_{T}.

In Equation 1, S̅ denotes an array of time information of a first bounding box included in a first tracklet, and S denotes an array of time information of a second bounding box included in a second tracklet.

In Equation 1, L_{match2} may be a second cost for bipartite matching of a tracklet level. In an example, combination of a pair of a first tracklet and a second tracklet, which minimizes the second cost according to an arg min function, may be determined to be the second bipartite matching result. In an example, a Hungarian algorithm may be used for bipartite matching.

Next, L_{match2} may be defined by Equation 2.

$${L}_{match 2} ( {T}^{S} , {\overline{T}}^{\overline{S}} ) = \frac{{\sum }_{j ∈ {\hat{σ}}_{B}} {L}_{match 1} ( {B}^{j} {\overline{, B}}^{j} )}{\vert {\hat{σ}}_{B} \vert} \qquad Equation 2$$

In Equation 2, \hat{σ}_{B} denotes a first bipartite matching result of a bounding box level corresponding to a first tracklet and a second tracklet. In Equation 2, T̅^{S̅} denotes any one first tracklet included in the first tracklet set, and T^{S} denotes any one second tracklet included in the second tracklet set. Next, B̅^{j} denotes any one first bounding box included in the first tracklet T̅^{S̅}, and B̅ⱼ denotes any one second bounding box included in the second tracklet T^{S}. An average of first costs L_{match1} of pairs of the first bounding box and the second bounding box included in \hat{σ}_{B} may be determined to be a second cost of the first tracklet. T̅^{S̅} and the second tracklet T^{S}.

In example, the first bipartite matching result may be represented by Equation 3 below.

$$\partial \text{?} = arg min \text{?} \sum \text{?} {L}_{match 1} ( B \text{?} , \overline{B} \text{?} ) \qquad Equation 3$$

$$\text{?} \text{indicates text missing or illegible when filed}$$

In Equation 3, \hat{σ}_{B} denotes a first bipartite matching result of a bounding box level corresponding to a first tracklet and a second tracklet. σ_{B} denotes any one among all combinations P₁_{_{N}} of possible bipartite matching between the first tracklet and the second tracklet.

In Equation 3, B̅ and B denote two tracklets to be compared, which may be the first tracklet and the second tracklet, respectively. As described above, the first tracklet may be a set of first bounding boxes and the second tracklet may be a set of second bounding boxes. Bᵢ denotes any one second bounding box included in B, and B̅_{σ}_{_{B}}(i) denotes a first bounding box determined to be a pair of Bᵢ in σ_{B}.

In Equation 3, S denotes an array including the time information of a first bounding box included in the first tracklet, and S̅ denotes an array including the time information of a second bounding box included in the second tracklet. |S∩S̅| may be a condition for determining a pair of a first bounding box and a second bounding box of which the time intervals overlap. In an example, a first cost for a first bounding box and a second bounding box of which the time intervals do not overlap may be determined to be a maximum value predetermined corresponding to the first cost or a sufficiently large value.

Next, L_{match1} may be a first cost for bipartite matching of a bounding box level. A combination of a pair of a first bounding box and a second bounding box, which minimizes the first cost according to an arg min function, may be determined to be the first bipartite matching result. For example, a Hungarian algorithm may be used for bipartite matching.

In an example, L_{match1} may be defined by Equation 4.

$${L}_{match 1} ( {B}_{i} \text{?} {\overline{B}}_{{σ}_{B}} \text{?} ) = - {\overline{p}}_{{σ}_{B} ( i )} ( c \text{?} ) + {L}_{box} ( {b}_{i} \text{?} {\overline{b}}_{{σ}_{B}} \text{?} ) \qquad Equation 4$$

$$\text{?} \text{indicates text missing or illegible when filed}$$

In Equation 4, cᵢ, which is a class of a second bounding box, denotes the class information of Bᵢ, which is GT. p̅_{σ}_{_{B}}(i) denotes a probability that a first bounding box is classified into cᵢ. As p̅_{σ}_{_{B}}(i) increases, a similarity between a first bounding box and a second bounding box is determined to be higher.

In an example, L_{box} is a Euclidean distance between two vectors and defined by Equation 5.

$${L}_{box} ( {b}_{i} \text{?} {\overline{b}}_{{σ}_{B}} \text{?} ) = ‖ {b}_{i} - {\overline{b}}_{{σ}_{B}} \text{?} ‖ \qquad Equation 5$$

$$\text{?} \text{indicates text missing or illegible when filed}$$

In Equation 5, bᵢ denotes a vector corresponding to a second bounding box, and b̅_{σ}_{_{B}}(i) denotes a vector corresponding to a first bounding box determined to be a pair of bᵢ in σ_{B}. A vector b corresponding to a bounding box may include coordinates (e.g., (x, y, z)) of the bounding box, the size (e.g., a weight or a height) of the bounding box, and a rotation degree (e.g., a yaw) of the bounding box. In an example, the vector corresponding to the bounding box may be defined by b=(x, y, z, width, length, height, yaw).

In an example, the method of training an object detector may include operation 150 of assigning a second tracklet determined to form a pair with first tracklets to GT data of the first tracklet, based on the second bipartite matching result. In other words, the second tracklet may have been determined to be paired with the first tracklets (i.e., as a paired first tracklet and second tracklet) and this may be auto-labeled to the GT data of the first tracklets based on the second bipartite matching result. By determining a pair of a first tracklet and a second tracklet through bipartite matching of a bounding box level and bipartite matching of a tracklet level, the accuracy of auto-labeling, which assigns GT data to data estimated by the object detector, may be improved.

In an example, the method of training an object detector may further include an operation of training the object detector based on the GT data of the first tracklet. The object detector may be trained to output the second tracklet assigned to the GT data of the first tracklet corresponding to an input frame. In an example, a refinement module of a 2-stage detector may be trained based on the second tracklet assigned to the GT data of the first tracklet.

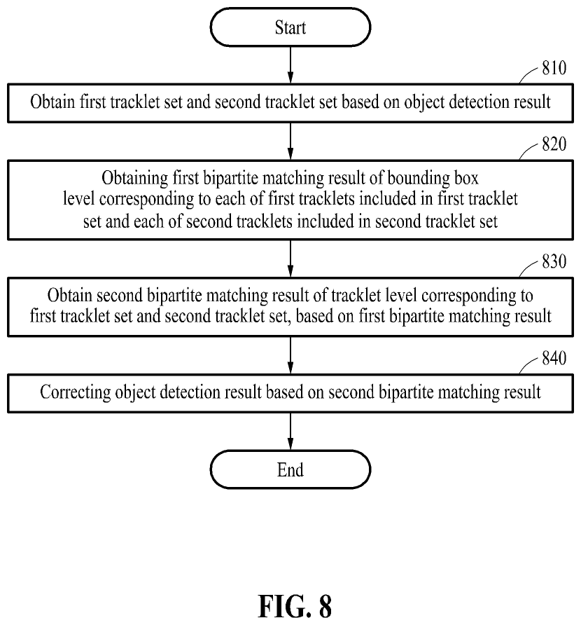

FIG. 8 illustrates an example object detection method according to one or more embodiments.

Referring to FIG. 8, in a non-limiting example, the object detection method according may include operation 810 of obtaining a first tracklet set and a second tracklet set based on an object detection result, operation 820 of obtaining a first bipartite matching result of a bounding box level corresponding to each of first tracklets included in the first tracklet set and each of second tracklets included in the second tracklet set, operation 830 of obtaining a second bipartite matching result of a tracklet level corresponding to the first tracklet set and the second tracklet set, based on the first bipartite matching result, and operation 840 of correcting the object detection result based on the second bipartite matching result.

The object detection result may include a result of detecting an object corresponding to input data in an object detector (or an object detection model). The object detector may include various types of object detectors and may include, for example, at least one of object detectors of a 2-stage detector type and a 1-stage detector type. The input data of the object detector may include at least one type of data among an image, a video, and a point cloud. Unlike the method described above with reference to FIG. 1, both the first tracklet set and the second tracklet set that are obtained in operation 810 may be obtained based on an object detection result output from the object detector. In an example, the first tracklet set and the second tracklet set may include a tracklet corresponding to the same object.

In an example, operation 840 of correcting the object detection result may include an operation of synthesizing the first tracklet and the second tracklet that are determined to each be part of a pair of tracklets (i.e., a paired first tracklet and second tracklet) that make up the second bipartite matching result. In example, the synthesizing of the first tracklet and the second tracklet may be performed in various methods of operating a value of the first tracklet and a value of the second tracklet, including the summing of the first tracklet and the second tracklet, the performing of a weighted sum on the first tracklet and the second tracklet, or the averaging of the first tracklet and the second tracklet. By synthesizing the first tracklet and the second tracklet determined to be a pair through double bipartite matching including bipartite matching of a bounding box level and bipartite matching of a tracklet level, the accuracy of the object detection result may be improved.

In an example, when a threshold second cost is established, when a second cost of the pair of the first tracklet and the second tracklet exceeds that threshold, the first and second tracklets are determined to be unmatched, and a probability of an error within the object detection result may decrease by removing the tracklets that fail to be matched.

In an example, operation 810 of obtaining the first tracklet set and the second tracklet set may include an operation of obtaining the first tracklet set corresponding to a trajectory of each of detected objects, based on an object detection result output from a first object detector corresponding to a plurality of frames and an operation of obtaining the second tracklet set corresponding to a trajectory of each of detected objects, based on an object detection result output from a second object detector corresponding to the plurality of frames. In other words, the first tracklet set and the second tracklet set may be tracklet sets obtained from object detection results output from different object detectors corresponding to the same input data.

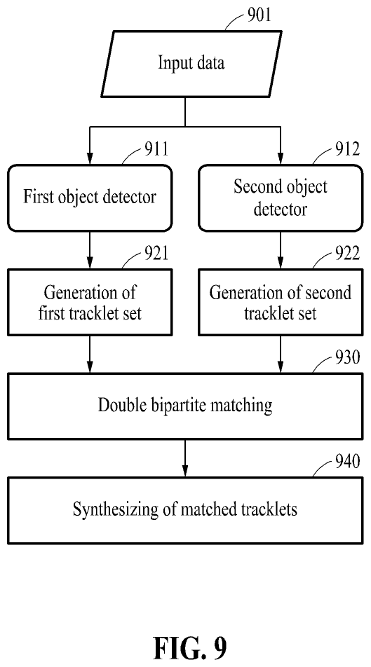

FIG. 9 illustrates an example method of double bipartite matching of a tracklet set obtained from object detection results of different object detectors according to one or more embodiments.

Referring to FIG. 9, in a non-limiting example, with respect to input data 901, an object detection result of a first object detector 911 and an object detection result of a second object detector 912 may be obtained. A first tracklet set may be generated in operation 921, based on the object detection result obtained in the first object detector 911. A second tracklet set may be generated in operation 922, based on the object detection result obtained in the second object detector 911.

The first tracklet set and the second tracklet set that are obtained from the object detection results of the different object detectors may be matched through double bipartite matching 930. In an example, the double bipartite matching 930 may correspond to operations 130 and 140 as described above in greater detail with reference to FIG. 1. A pair of first and second tracklets that were matched together into, for example, the paired first tracklet and second tracklet, as a result of the double bipartite matching 930 may be determined.

In an example, the two tracklet sets which were matched as a pair as a result of the double bipartite matching 930, in the synthesizing performed in operation 940, a highly accurate object detection result may be obtained. In other words, the correcting of an object detection result by synthesizing a pair of tracklet sets determined through double bipartite matching, in an example, may correspond to an ensemble technique of two different object detectors.

Referring back to FIG. 8, in a non-limiting example, operation 810 of obtaining the first tracklet set and the second tracklet set may include an operation of obtaining the first tracklet set corresponding to a respective trajectory of each respective detected object of detected objects, based on an object detection result output from an object detector corresponding to a plurality of frames obtained from a first sensor and an operation of obtaining the second tracklet set corresponding to a respective trajectory of each respective detected object of the detected objects, based on an object detection result output from an object detector corresponding to a plurality of frames obtained from a second sensor.

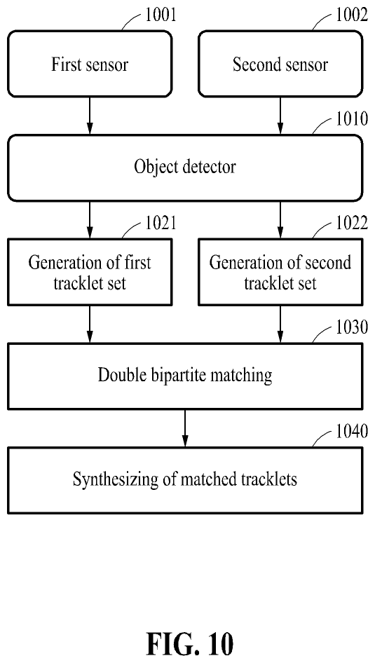

FIG. 10 illustrates an example method of double bipartite matching of a tracklet set obtained from object detection results corresponding to signals of different sensors according to one or more embodiments.

Referring to FIG. 10, in a non-limiting example, a signal received from a first sensor 1001 and a signal received from a second sensor 1002 may be obtained. The first sensor 1001 and the second sensor 1002 may be placed in different positions and/or locations. In an example, the signal received from the first sensor 1001 and the signal received from the second sensor 1002 may be data obtained by sensing the same scene at the same time.

An object detection result of an object detector 1010 may be obtained corresponding to the signal received from the first sensor 1001, and a first tracklet set may be generated in operation 1021, based on the object detection result corresponding to the signal received from the first sensor 1001. An object detection result of the object detector 1010 may be obtained corresponding to the signal received from the second sensor 1002, and a second tracklet set may be generated in operation 1022, based on the object detection result corresponding to the signal received from the second sensor 1002. In an example, the object detection result corresponding to the signal received from the first sensor 1001 and the object detection result corresponding to the signal received from the second sensor 1002 may be obtained from the same object detector 1010. However, the object detection result corresponding to the signal received from the first sensor 1001 and the object detection result corresponding to the signal received from the second sensor 1002 may also be obtained from different object detectors.

A first tracklet set and a second tracklet set obtained from object detection results corresponding to signals received from different sensors may be matched through double bipartite matching 1030. The double bipartite matching 1030 may correspond to operations 130 and 140 described above in greater detail with reference to FIG. 1. A pair of first and second tracklets matched as a result of the double bipartite matching 1030 may be determined. In operation 1040, the two tracklet sets matched as a pair as a result of the double bipartite matching 1030, a highly accurate object detection result may be obtained by the synthesizing of matched tracklets.

FIG. 11 illustrates an example configuration of an apparatus according to one or more embodiments.

Referring to FIG. 11, in a non-limiting example, an electronic apparatus 1100 may include a processor 1201, a memory 1203, and a communication module 1105. The electronic apparatus 1100 may include an apparatus for performing the method of training the object detector described above with reference to FIG. 1 and/or the object detection method described above with reference to FIG. 8.

The processor 1101 may be configured to execute programs or applications to configure the processor 1101 to control the electronic apparatus 1100 to perform one or more or all operations and/or methods involving object detection, and may include any one or a combination of two or more of, for example, a central processing unit (CPU), a graphic processing unit (GPU), a neural processing unit (NPU) and tensor processing units (TPUs), but is not limited to the above-described examples. In an example, the processor 1101 may perform at least one operation described above with reference to FIGS. 1 to 10.

In an example, the processor 1101 may perform at least one operation of obtaining a first tracklet set based on an object detection result output corresponding to a plurality of frames, obtaining a second tracklet set from GT data predetermined corresponding to the plurality of frames, obtaining a first bipartite matching result of a bounding box level corresponding to each of first tracklets included in the first tracklet set and each of second tracklets included in the second tracklet set, obtaining a second bipartite matching result of a tracklet level corresponding to the first tracklet set and the second tracklet set, based on the first bipartite matching result, and assigning a second tracklet determined to be the second part of a pair of a paired first tracklet that is paired with its respective paired second tracklet, to GT data for that paired first tracklet, based on the second bipartite matching result.

In an example, the processor 1101 may perform at least one operation of obtaining a first tracklet set and a second tracklet set based on an object detection result, obtaining a first bipartite matching result of a bounding box level corresponding to each of first tracklets included in the first tracklet set and each of second tracklets included in the second tracklet set, obtaining a second bipartite matching result of a tracklet level corresponding to the first tracklet set and the second tracklet set, based on the first bipartite matching result, and correcting the object detection result based on the second bipartite matching result.

The memory 1103 may include computer-readable instructions. The processor 1101 may be configured to execute computer-readable instructions, such as those stored in the memory 1103, and through execution of the computer-readable instructions, the processor 1101 is configured to perform one or more, or any combination, of the operations and/or methods described herein. The memory 1101 may be a volatile or nonvolatile memory. The memory 1103 may store data related to the method of training the object detector and/or the object detection method described above with reference to FIGS. 1 to 10. In an example, the memory 1103 may store data generated during the process of performing the method of training the object detector and/or the object detection method or data necessary for performing the method of training the object detector and/or the object detection method. In an example, the memory 1103 may store a bipartite matching result of a first tracklet and a second tracklet. In an example, the memory 1103 may store a weight of at least one layer included in the object detector.

In an example, the communication module 1105 may provide a function for the electronic apparatus 1100 to communicate with another electronic device or another server through a network. In other words, the electronic apparatus 1100 may be connected to an external device (e.g., a terminal of a user, a sensor configured to sense input data, a server, or a network) through the communication module 1105 and may exchange data with the external device.

In an example, the memory 1103 may not be a component of the electronic apparatus 1100 and may be included in an external device accessible by the electronic apparatus 1100. In this case, the electronic apparatus 1100 may receive data stored in the memory 1103 included in the external device and may transmit data to be stored in the memory 1103 through the communication module 1105.

According to an example, the memory 1103 may store a program configured to implement the method of training the object detector and/or the object detection method described above with reference to FIGS. 1 to 10. The processor 1101 may execute the program stored in the memory 1103 and may control the electronic apparatus 1100. Code from the program executed by the processor 1101 may be stored in the memory 1103.

The electronic apparatus 1100 according to an embodiment may further include other components not shown in the drawings. In an example, the electronic apparatus 1100 may further include an input/output interface including an input device and an output device as the means of interfacing with the communication module 1105. In addition, the electronic apparatus 1100 may further include other components, such as a transceiver, various sensors, or a database.

The processors, memory, electronic apparatus, backbone 210, region proposal module 220, refinement module 230, first object detector 911, second object detector 912, first sensor 1001, second sensor 1002, object detector 1030, electronic apparatus 1100, processor 1101, memory 1103, and communication module 1105 described herein and disclosed herein described with respect to FIGS. 1-11 are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-10 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A method of training an object detector, the method comprising:
obtaining a first tracklet set based on an object detection result output corresponding to a plurality of frames;
obtaining a second tracklet set from ground truth data predetermined corresponding to the plurality of frames;
obtaining a first bipartite matching result of a bounding box level, the bounding box level corresponding to each of first tracklets comprised in the first tracklet set and each of second tracklets comprised in the second tracklet set;
obtaining a second bipartite matching result of a tracklet level, the tracklet level corresponding to the first tracklet set and the second tracklet set, based on the first bipartite matching result; and
assigning a second tracklet determined to be one of a pair including a first tracklet, as a paired first tracklet and second tracklet, to ground truth data of the first tracklet, based on the second bipartite matching result.

2. The method of claim 1, wherein the obtaining the first bipartite matching result comprises:
obtaining the first bipartite matching result based on a first cost, the first cost resulting from a first similarity of a first bounding box comprised in the first tracklet and a second bounding box comprised in the second tracklet.

3. The method of claim 2, wherein the first cost is determined based on at least one of:
a probability in which a first class of the first bounding box is a similar class as a second class of the second bounding box;
a difference between first coordinates of the first bounding box and second coordinates of the second bounding box;
a difference between a first size of the first bounding box and a second size the second bounding box; and
a difference in a rotation degree between the first bounding box and the second bounding box.

4. The method of claim 1, wherein the obtaining the second bipartite matching result comprises:
obtaining the second bipartite matching result based on a second cost, the second cost resulting from a second similarity of the first tracklet and the second tracklet determined from the first bipartite matching result.

5. The method of claim 1, wherein the obtaining the second bipartite matching result comprising:
obtaining a first cost of a first bounding box comprised in the first tracklet determined to be the paired first tracklet and a second bounding box comprised in the second tracklet, based on the first bipartite matching result;
determining a second cost of the first tracklet and the second tracklet, based on the obtained first cost; and
obtaining the second bipartite matching result based on the second cost.

6. The method of claim 1, wherein the object detector comprises an object detector of a 2-stage detector type, and
wherein the obtaining of the first tracklet set comprises obtaining the first tracklet set corresponding to respective trajectories of respective detected objects, based on an object detection result output from a region proposal module of the object detector corresponding to the plurality of frames.

7. The method of claim 1, further comprising training the object detector based on the ground truth data of the first tracklet.

8. The method of claim 1, wherein the first tracklet comprises a plurality of first bounding boxes corresponding to a time interval, and
the second tracklet comprises a plurality of second bounding boxes corresponding to the time interval.

9. An object detection method, the method comprising:
obtaining a first tracklet set and a second tracklet set based on an object detection result;
obtaining a first bipartite matching result of a bounding box level, the bounding box level corresponding to each of first tracklets comprised in the first tracklet set and each of second tracklets comprised in the second tracklet set;
obtaining a second bipartite matching result of a tracklet level, the tracklet level corresponding to the first tracklet set and the second tracklet set, based on the first bipartite matching result; and
correcting the object detection result based on the second bipartite matching result.

10. The object detection method of claim 9, wherein the correcting the object detection result comprises:
synthesizing a first tracklet of the first tracklets that is paired to a second tracklet of the second tracklets as a pair, the pair resulting from the second bipartite matching result.

11. The object detection method of claim 9, wherein the obtaining the first tracklet set and the second tracklet set comprises:
obtaining the first tracklet set corresponding to a first respective trajectory of a first respective detected object of first detected objects, based on a first object detection result output from a first object detector corresponding to a plurality of frames; and
obtaining the second tracklet set corresponding to a second respective trajectory of a second respective object of second detected objects, based on a second object detection result output from a second object detector corresponding to the plurality of frames.

12. The object detection method of claim 9, wherein the obtaining the first tracklet set and the second tracklet set comprises:
obtaining the first tracklet set corresponding to a first respective trajectory of a first respective detected object of first detected objects, based on a first object detection result output from a first object detector corresponding to a first plurality of frames obtained from a first sensor; and
obtaining the second tracklet set corresponding to a second respective trajectory of a second respective object of second detected objects, based on a second object detection result output from a second object detector corresponding to a plurality of frames obtained from a second sensor.

13. A non-transitory computer-readable storage medium storing instructions that, when executed by a processor, cause the processor to perform the method of claim 1.

14. An apparatus for training an object detector, the apparatus comprising:
processors configured to execute instructions; and
a memory storing the instructions, wherein execution of the instructions configures the processors to:
obtain a first tracklet set based on an object detection result output corresponding to a plurality of frames;
obtain a second tracklet set from ground truth data predetermined corresponding to the plurality of frames;
obtain a first bipartite matching result of a bounding box level, the bounding box level corresponding to each of first tracklets comprised in the first tracklet set and each of second tracklets comprised in the second tracklet set;
obtain a second bipartite matching result of a tracklet level, the tracklet level corresponding to the first tracklet set and the second tracklet set, based on the first bipartite matching result; and
assign a second tracklet determined to be one of a pair including a first tracklet, as a paired first tracklet and second tracklet, to ground truth data of the first tracklet, based on the second bipartite matching result.

15. The apparatus of claim 14, wherein the processors are further configured to:
when obtaining the first bipartite matching result, obtain the first bipartite matching result based on a first cost, the first cost resulting from a first similarity of a first bounding box comprised in the first tracklet and a second bounding box comprised in the second tracklet.

16. The apparatus of claim 14, wherein the processors are further configured to:
when obtaining the second bipartite matching result, obtain the second bipartite matching result based on a second cost, the second cost resulting from a second similarity of the first tracklet and the second tracklet determined from the first bipartite matching result.

17. The apparatus of claim 14, wherein the processors are further configured to, when obtaining the second bipartite matching result,
obtain a first cost of a first bounding box comprised in the first tracklet determined to be the paired first tracklet and a second bounding box comprised in the second tracklet, based on the first bipartite matching result,
determine a second cost of the first tracklet and the second tracklet, based on the obtained first cost, and
obtain the second bipartite matching result based on the second cost.

18. The apparatus of claim 14, wherein the object detector comprises an object detector of a 2-stage detector type, and
wherein the processors are further configured to:
when obtaining the first tracklet set, obtain the first tracklet set corresponding to respective trajectories of respective detected objects, based on an object detection result output from a region proposal module of the object detector corresponding to the plurality of frames.

19. The apparatus of claim 14, wherein the processors are further configured to train the object detector based on the ground truth data of the first tracklet.

20. An apparatus for object detection, the apparatus comprising:
processors configured to execute instructions; and
a memory storing the instructions, wherein execution of the instructions configures the processors to:
obtain a first tracklet set and a second tracklet set based on an object detection result,
obtain a first bipartite matching result of a bounding box level, the bounding box level corresponding to each of first tracklets comprised in the first tracklet set and each of second tracklets comprised in the second tracklet set,
obtain a second bipartite matching result of a tracklet level, the tracklet level corresponding to the first tracklet set and the second tracklet set, based on the first bipartite matching result, and
correct the object detection result based on the second bipartite matching result.
